(19) United States
(12) Patent Application Publication
(10) Pub. No.: US 2013/0073304 A1
(43) Pub. Date: Mar. 21, 2013

(54) METHOD AND SYSTEM FOR AUTO REBINDING OF PATIENT DEMOGRAPHIC DETAILS TO PATIENT MONITORING DEVICES

(71) Applicants: Nataraj Subbaraya Kuntagod, Bangalore (IN); Chinmoy Mukherjee, Bangalore (IN)

(72) Inventors: Nataraj Subbaraya Kuntagod, Bangalore (IN); Chinmoy Mukherjee, Bangalore (IN)

(73) Assignee: INFOSYS LIMITED, Bangalore (IN)

(21) Appl. No.: 13/614,342

(22) Filed: Sep. 13, 2012

(30) Foreign Application Priority Data
Sep. 20, 2011 (IN) 3246/CHE/2011

(51) Int. Cl. G06Q 50/22

(52) U.S. Cl. 705/2

(57) ABSTRACT

The present invention provides a middleware to automatically bind demographic details of a patient to at least one sensor included in a body worn monitoring device of the patient. In accordance with an embodiment, the middleware comprises a receiver module and an edge intelligence module. The receiver module receives identification code from a sensor associated with the patient, a unique patient identification code from a central server, and signals from each sensor associated with the patient. The edge intelligence module associates the unique patient identification code and the demographic details of the patient with each of the at least one sensor, and updates the central server with sensor identification code of each sensor associated with the unique patient identification code.

This application claims the benefit of Indian Patent Application Filing No. 3246/CHE/2011, filed Sep. 20, 2011, which is hereby incorporated by reference in its entirety.

### BACKGROUND

The invention relates to the field of remote patient monitoring system. In particular, the invention relates to a method and system for automatic rebinding of replaced network devices in a remote patient monitoring system.

In hospital patients often require continuous monitoring, so that development of any emergency health condition like arrhythmia could be detected and medical supervisor could be alerted to provide emergency care to the patient. Remote patient monitoring uses computerized technology to track patient's vital signs and health status without face to face contact. There are many low cost, efficient, easy to use diagnostic monitoring devices such as medical sensors that measure at least one physiological parameter such as ECG, blood pressure, heart rate, oxygen saturation level, glucose level, etc. and detect at least one predetermined event of a patient's health condition in a remote patient monitoring system. In the remote monitoring scenario, the monitoring devices such as sensors have to be associated to at least one demographic details of the patient such as, for example, name, age, gender and bed location, so that when an emergency event is encountered the medical supervisor could identify the patient for providing emergency care.

However, when the monitoring device is changed due to low battery life or device fault or is replaced with a different type of monitoring device, the patient has to be “re-associated” with the new set of replaced devices manually. This manual re-association is highly error prone. The problem becomes more pronounced in case of ambulatory/in hospital monitoring of patients when things are more dynamic in nature, and it becomes extremely difficult to associate a patient with their context data sources dynamically. When such a medical event that needs attention is encountered, some other patient may be wrongly identified if the replaced monitoring devices are not associated with the patient demographic details during the monitoring period and may result in wrong or denied treatments. Such an emergency condition that is not tackled properly may lead to adverse effects on the patient's health including death of patient.

There has to be a system and a method to provide dynamic re-association of patient demographics to the monitoring devices and context sources such as medical sensors when the monitoring devices are changed without requiring any manual intervention.

Thus, there is a need for a system and a method that provides fail-safe automatic rebinding of monitoring entities with the demographic details of the patient in a patient monitoring network without requiring manual intervention.

### SUMMARY OF THE INVENTION

The present invention provides a system to enable a middleware device in a patient monitoring network to automatically bind the demographic details of a patient to at least one body worn sensor of the patient, wherein the patient monitoring network includes a central server and network devices such as body worn sensors and a middleware device. The system includes a receiver module configured to receive a sensor identification code from the sensor associated with the patient, receive a unique patient identification code from the central server and receive signals from each sensor associated with the patient. The system further includes an edge intelligence module to associate the demographic details of the patient and the unique patient identification code with each sensor associated with the patient in the patient monitoring network, and updates the central server with the sensor identification code of each sensor associated with the patient in the patient monitoring network. The system further includes a transmitter module configured to transmit the signals received from each sensor associated with the patient to the central server.

The present invention provides a system for automatic rebinding of demographic details of a patient to a new sensor that has replaced a previously associated sensor in a patient monitoring network. The system includes a central server and a middleware device, wherein the central server is configured to receive signals from each sensor associated with the patient through the intermediate middleware device and generate a unique patient identification code when it encounters a unique combination of unbound sensor and middleware identification codes thereby associating them with the demographic details of the patient. The middleware device is configured to store the unique patient identification code generated by the central server. Further the middleware device comprises a receiver module to receive the sensor identification code from the new sensor and an edge intelligence module configured to update the new sensor with the unique patient identification code and associate the demographic details of the patient to the new sensor. The edge intelligence module of the middleware device is further configured to update the central server's previously associated sensor's identification code with the identification code of the new sensor that has replaced the previously associated sensor.

The present invention also provides a system for automatic rebinding of demographic details of a patient to a new middleware device that has replaced a previously associated middleware device in a patient monitoring network. The system includes a central server and at least one sensor that have previously been associated with the patient monitoring network, wherein the central server is configured to receive signals from each sensor associated with the patient through the middleware device. The sensor is configured to store its identification code and the unique patient identification code generated by the central server. Further the new middleware device comprises a receiver module to receive the sensor identification code and the unique patient identification from the sensor, and an edge intelligence module configured to update the new middleware with the unique patient identification code and associate the demographic details of the patient to the new replaced middleware device. The edge intelligence module of the middleware device is further configured to update the central server's previously associated middleware device's identification code with the identification code of the new middleware device that has replaced the previously associated middleware device.

The present invention further provides a method for automatic rebinding of demographic details of a patient to a network device that has replaced a previously associated network device in the remote patient monitoring network, wherein the patient monitoring network includes a central server and network devices such as body worn monitoring sensors and a middleware device. The method includes retrieving the unique patient identification code generated by the central server from a network device in the patient monitoring network for associating the demographic details of the patient to the previously associated network device. On retrieving the unique patient identification code from the network device associated with the patient, the demographic details of the patient are associated with the replaced network device by updating it with the unique patient identification code generated by the central server. The method further includes associating the replaced network device in the patient monitoring network with the central server and updating the previously associated network device identification code in the central server with the replaced network device identification code.

### DRAWINGS

These and other features, aspects, and advantages of the present invention will be better understood when the following detailed description is read with reference to the accompanying drawings in which like characters represent like parts throughout the drawings, wherein:

FIG. 1 shows a patient monitoring network 100 in accordance with an embodiment of the present invention;

FIG. 2 is a block diagram of middleware device 104, in accordance with an embodiment of the present invention;

FIG. 3 shows a sequence diagram with a set of interactions to bind the primary components with a patient in a patient monitoring network with the help of a medical supervisor, in accordance with an embodiment of the present invention;

FIG. 4 shows a sequence diagram with a set of interactions to automatically rebind a replaced sensor with the patient in the patient monitoring network, in accordance with an embodiment of the present invention;

FIG. 5 shows a sequence diagram with a set of interactions to automatically rebind a replaced middleware device with the patient in the patient monitoring network, in accordance with an embodiment of the present invention;

FIG. 6 is a flowchart illustrating a method for automatically rebinding a replaced network device with the patient in the patient monitoring network, in accordance with an embodiment of the present invention; and

FIG. 7 illustrates a generalized example of a computing environment 700.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

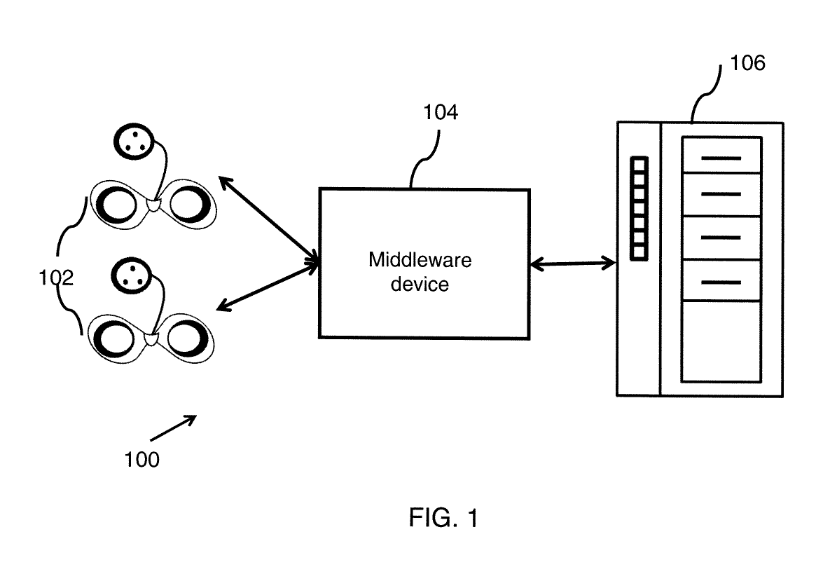

FIG. 1 shows a patient monitoring network 100 in accordance with an embodiment of the present invention. Patient monitoring network 100 includes the following primary components: sensors 102 included in a body worn monitoring device of the patient, a middleware device 104 dedicated to each patient, and a central server 106.

Patient monitoring network 100 is used to exchange or share data between the interconnected primary components that are linked together using communication channels. The mode of communication between the interconnected primary components may be wireless communication, wired communication or both.

Sensors 102 included in the body worn monitoring device of the patient monitor and measure body conditions, metabolism, or other functions indicative of the patient's health. Sensors 102 transmit the observed measurements of the patient in the form of electric signals. It should be noted that the term “body worn monitoring device” means that the device is connected, affixed or attached directly to the body of the patient. Examples of the sensors 102 included in the body worn monitoring device of the patient include, but not limited to, heart rate sensor, pulse rate sensor, Electrocardiogram sensor. In an embodiment, sensors 102 have storage space to store information. It will be apparent that any number of sensors 102 may be connected to the patient. Each sensor from among sensors 102 is associated and identified with a sensor identification code.

Sensors 102 transmit the signals to central server 106 via the dedicated middleware device 104. As used herein, the term “dedicated” means that each patient in the patient monitoring network 100 is associated with a unique middleware device 104. Examples of middleware device 104 include, but are not limited to, a gateway, a mobile phone, a personal digital assistant (PDA), and a personal computer. Each middleware device 104 is associated and identified with a middleware identification code.

Central server 106 receives the signals from sensors 102 associated with each patient through middleware device 104. Central server automatically notifies lists of unbound and unique combination of middleware device 104 identification code and sensors identification code 102 to the medical supervisor, the medical supervisor associates the unbound entity to demographic details for a particular patient. Once the demographic details of the patient are associated, the central server 106 generates a unique patient identification code. In the context of this disclosure, the term “unbound” refers to sensors 102 and middleware device 104 that have a null patient identification code. The central server updates the unique patient identification code to middleware device 104, which in turn updates the unique patient identification code to all sensors 102 attached to the middleware device. The demographic details for each patient monitoring system may vary accordingly. Demographic details include, but are not restricted to, name, age, gender, and bed location. After binding sensors 102 and middleware device 104 with the unique patient identification code, central server 106 monitors the signals from sensors 102 and in case an emergency condition is developed in patient it sends alert to a medical supervisor along with patient demographic details like name, bed location etc. The medical supervisor can then visit the patient in person and provide proper medical care for patients monitored in patient monitoring network 100.

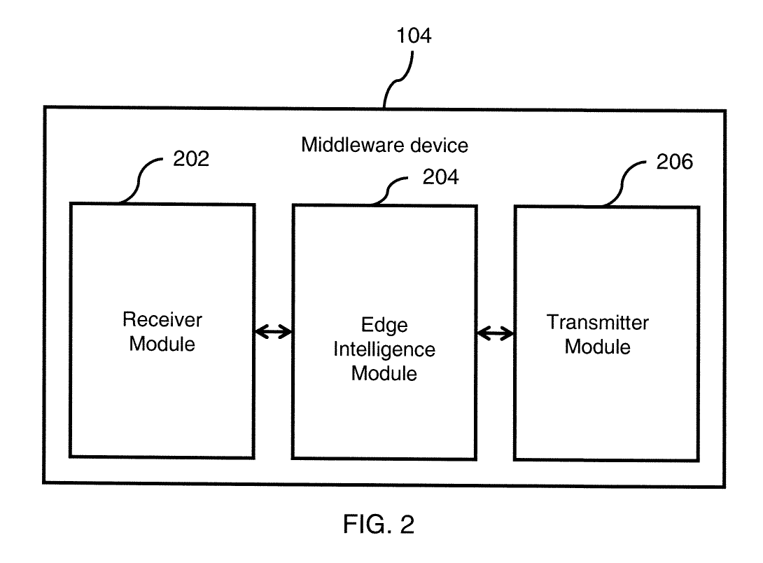

FIG. 2 is a block diagram of middleware device 104, in accordance with an embodiment of the present invention. Middleware device 104 includes a receiver module 202, an edge intelligence module 204, and a transmitter module 206.

Receiver module 202 of middleware device 104 is configured to receive the sensor identification code, the unique patient identification code, and receive the signals from each sensor 102 (shown in FIG. 1) associated with the patient.

Edge intelligence module 204 is configured to associate the demographic details of the patient with at least one of sensors 102 by storing the unique patient identification code generated by central server 106 (shown in FIG. 1) in sensor 102, and register or update the central server 106 with the sensor identification code or the middleware identification code associated with each patient. Edge intelligence module 204 stores the unique patient identification code in one or more of sensors 102 when sensors 102 is newly added in patient monitoring network 100 (shown in FIG. 1) or when sensor 102 is replaced with a new sensor. Similarly, edge intelligence module 204 registers the sensor identification code and the middleware device identification code when one or more of sensors 102 and middleware device 104 are newly added to patient monitoring network 100. Further, edge intelligence module 204 updates the sensor identification code or the middleware device identification code when at least one sensor among sensors 102 or the middleware device 104 is replaced with another sensor or a middleware device respectively.

Transmitter module 206 is configured to transmit the signals received from each of the sensors 102 associated with each patient to central server 106.

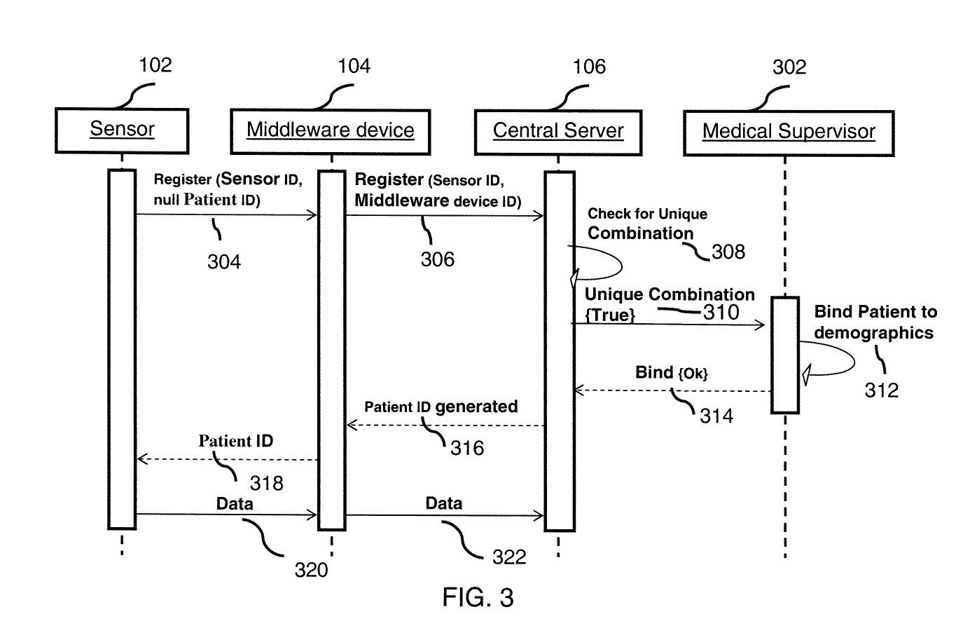

FIG. 3 shows a sequence diagram with a sequence of interactions between the Sensors 102, Middleware device 104, Central Server 106 and Medical Supervisor 302 to associate and bind the demographic details of the patient in the patient monitoring network 100, in accordance with an embodiment of the present invention.

Medical supervisor 302 maybe any of an attender, a nurse, a compounder, a doctor, a supervisor and a system administrator. Medical supervisor 302 provides manual intervention to invoke central server 106 to generate the unique patient identification code when central server 106 encounters an unbound unique combination of the sensors identification code and the middleware device identification code. After generating the unique patient identification code, central server 106 binds the unique patient identification code with associated sensors 102 and middleware device 104.

In an embodiment of the present invention, associating demographic details of the patient with sensors 102 and middleware device 104 involves the following steps:

At step 304, one or more of sensors 102 that are unbound in a patient monitoring network sends a registration request to unbound middleware device 104 with the sensor identification code and a null patient identification code.

At step 306, unbound middleware device 104 sends a registration request to central server 106 with the sensor identification code and the middleware identification code.

At step 308, central server 106 checks for the unique combination of the sensor identification code and the middleware identification code of unbound sensors 102 and middleware device 104. When central server encounters such unique combinations of identification codes, it returns a true value.

At step 310, when the check for unique combination in the central server 106 returns a true value for unbound sensors 102 and middleware device 104, a notification containing a true value for unique combination attribute is sent to medical supervisor 302.

At step 312, medical supervisor 302 associates the demographic details of the patient in patient monitoring network 100.

At step 314, medical supervisor 302 returns a true value for bind attribute to central server 106 after associating the demographic details of the patient.

At step 316, central server 106 generates a unique patient identification code and communicates it to middleware device 104 via a preferred communication mode.

At step 318, receiver module 202 (shown in FIG. 2) of middleware device 104 receives the unique patient identification code generated by central server 106. Edge intelligence module 204 (shown in FIG. 2) retrieves the unique patient identification code from receiver module 202 and stores the unique patient identification code in middleware device 104 associated with the patient. Edge intelligence module 204 (shown in FIG. 2) updates the unique patient identification code to sensors 102. Sensor 102 stores the unique patient identification code in its memory. Thus, by storing the unique patient identification code generated by the central server 106 in sensors 102 and middleware device 104 the demographic details of the patient are associated with the sensors 102 and the middleware device 104.

At step 320, when the unique patient identification code is stored or updated in sensor 102, sensor 102 transmits the signals or observed measurements of the patient to receiver module 202.

At step 322, transmitter module 206 (shown in FIG. 2) retrieves the received signals from sensor 102 and transmits the retrieved signals to central server 106.

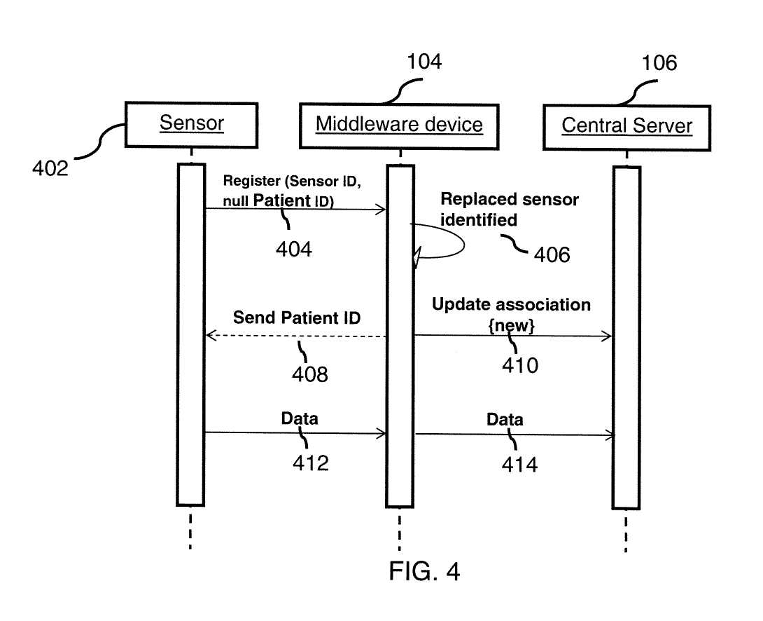

FIG. 4 shows a sequence diagram with a sequence of interactions to automatically rebind the demographic details of a patient in patient monitoring network 100 to a sensor 402 that has replaced previously associated sensors 102 in the patient monitoring network 100, in accordance with an embodiment of the present invention. FIG. 4 includes sensor 402, middleware device 104 and central server 106.

The process of automatically rebinding the demographic details of the patient to sensor 402 that has replaced the previously associated sensors 102 in the patient monitoring network 100 involves the following steps:

At step 404, sensor 402 that has replaced the previously associated sensors 102 sends a registration request containing the sensor identification code and a null patient identification code to middleware device 104.

At step 406, receiver module 202 (shown in FIG. 2) of middleware device 104 receives the sensor identification code of replaced sensor 402 and the null patient identification code. Edge intelligence module 204 (shown in FIG. 2) of middleware device 104 identifies sensor 402 as a replaced sensor.

At step 408, edge intelligence module 204 of middleware device 104 associates the demographic details of the patient with replaced sensor 402 by sending the unique patient identification code to the replaced sensor 402. The replaced sensor 402 updates the null patient identification code with the unique patient identification code.

At step 410, edge intelligence module 204 sends a request to central server 106 to update the identification code of previously associated sensor 102 with the identification code of replaced sensor 402.

At step 412, when sensor 402 that has replaced sensor 102 has been associated with the unique patient identification code, sensor 402 transmits the signals or observed measurements of the patient to receiver module 202 of middleware device 104.

At step 414, transmitter module 206 retrieves the received signals from sensor 402 and transmits the retrieved signals to central server 106.

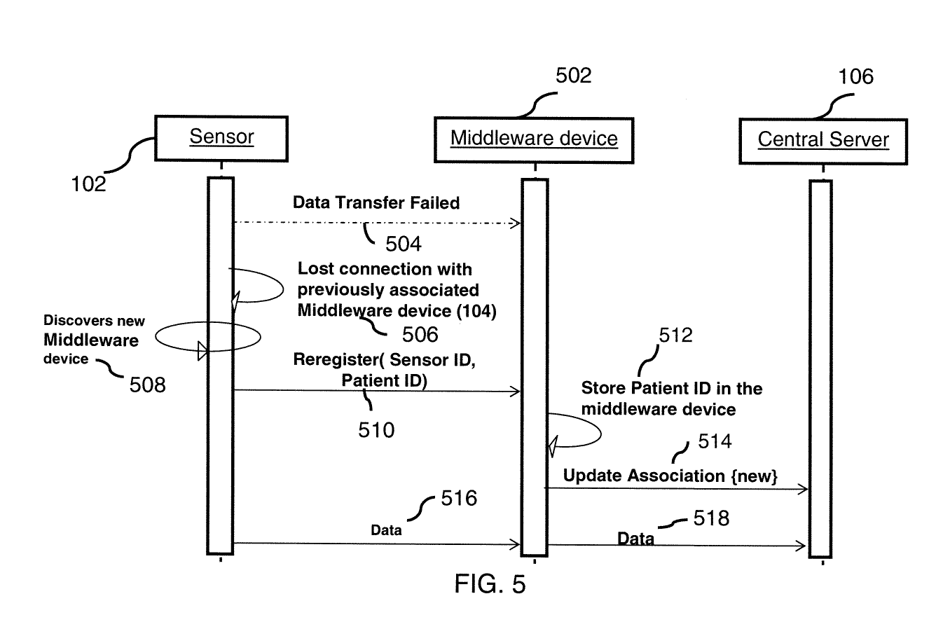

FIG. 5 shows a sequence diagram with a sequence of interactions to automatically rebind the demographic details of the patient in patient monitoring network 100 (not shown in the figure) to a middleware device 502 that has replaced a previously associated middleware device 104, in accordance with an embodiment of the present invention. FIG. 5 includes sensors 102, a middleware device 502 and central server 106.

The process of automatically rebinding the demographic details of the patient to middleware device 502 that has replaced the previously associated middleware device 104 in patient monitoring network 100 involves the following steps:

At step 504, sensors 102 associated with the demographic details of the patient and having the unique patient identification code transmits the signals or the observed measurements of the patient to middleware device 502.

At step 506, sensor 102 identifies that the connection between the sensors 102 and the previously associated middleware device 104 has lost, and the data transfer to the previously associated middleware device has failed.

At step 508, sensor 102 discovers new middleware device 502, which has replaced the previously associated middleware device 104.

At step 510, sensor 102 associated with the demographic details of the patient and having the unique patient identification code, reregisters with the replaced middleware device by sending a registration request with sensor identification code and the unique patient identification code.

At step 512, Middleware device 502 retrieves the unique patient identification code and associates itself with the demographic details of the patient by storing the retrieved unique patient identification code in the middleware device 502.

At step 514, middleware device 502 sends a request to central server 106 to update the identification code of the previously associated middleware device 104 with the identification code of the replaced middleware device 502.

At step 516, sensors 102 transmits the signals or observed measurements of the patient to middleware device 502 that has replaced the previously associated middleware device 104.

At step 518, when the middleware device 502 has been associated with the unique patient identification code, middleware device 502 retrieves the received signals from sensors 102 and transmits the retrieved signals to central server 106.

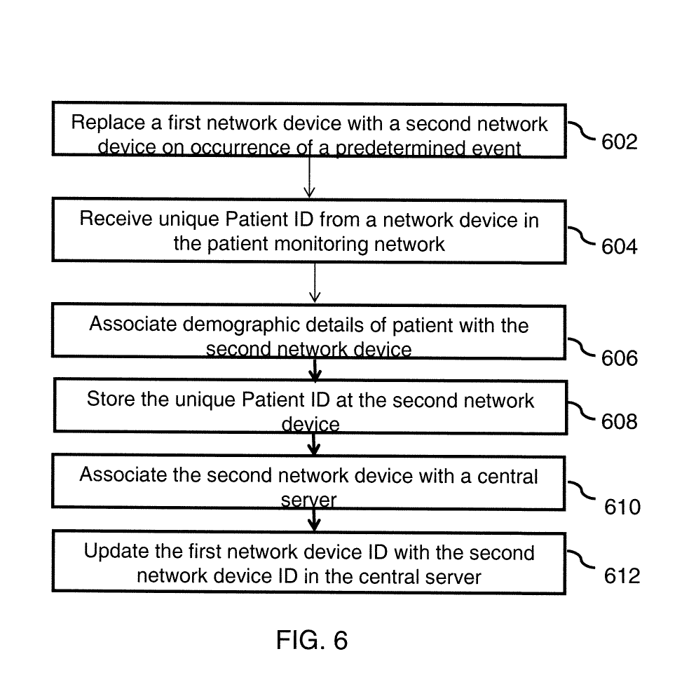

FIG. 6 is a flowchart describing a method for automatically rebinding a replaced network device with a patient in a patient monitoring network, in accordance with an embodiment of the present invention. It may be noted that the term “network device” may refer to at least one of sensors 102 or middleware device 104. Further, the term “first network device” may refer to at least one of sensors 402 or middleware device 502 already existing in the patient monitoring network 100 and the term “second network device” may refer to at least one of sensors 402 or middleware device 502 that has replaced the first network device.

The process of automatically rebinding the demographic details of the patient to second network device that has replaced the first network device in the patient monitoring network 100 involves the following steps:

At step 602, the first network device is replaced with the second network device when a predetermined event is encountered. The predetermined event include but not limited to, low battery life, device fault or a different type of monitoring device has to be included in the patient monitoring network 100.

At step 604, the second network device receives the unique patient identification code from at least one network device associated with the patient in the patient monitoring network 100, wherein the at least one network device excludes the first network device.

At step 606, the demographic details of the patient are associated with the second network device.

At step 608, the unique patient identification code is stored at the second network device.

At step 610, the second network device associates itself with central server 106.

At step 612, central server 106 updates the unique identification code of the first network device with the identification code of the second network device.

Exemplary Computing Environment

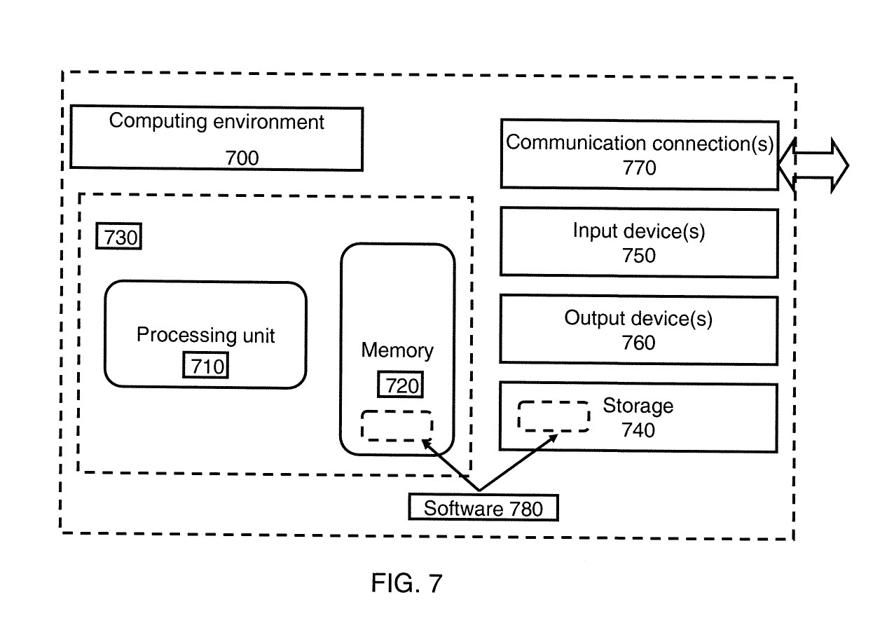

One or more of the above-described techniques can be implemented in or involve one or more computer systems. FIG. 7 illustrates a generalized example of a computing environment 700. The computing environment 700 is not intended to suggest any limitation as to scope of use or functionality of described embodiments.

With reference to FIG. 7, the computing environment 700 includes at least one processing unit 710 and memory 720. In FIG. 7, this most basic configuration 730 is included within a dashed line. The processing unit 710 executes computer-executable instructions and may be a real or a virtual processor. In a multi-processing system, multiple processing units execute computer-executable instructions to increase processing power. The memory 720 may be volatile memory (e.g., registers, cache, RAM), non-volatile memory (e.g., ROM, EEPROM, flash memory, etc.), or some combination of the two. In some embodiments, the memory 720 stores software 780 implementing described techniques.

A computing environment may have additional features. For example, the computing environment 700 includes storage 740, one or more input devices 750, one or more output devices 760, and one or more communication connections 770. An interconnection mechanism (not shown) such as a bus, controller, or network interconnects the components of the computing environment 700. Typically, operating system software (not shown) provides an operating environment for other software executing in the computing environment 700, and coordinates activities of the components of the computing environment 700.

The storage 740 may be removable or non-removable, and includes magnetic disks, magnetic tapes or cassettes, CD-ROMs, CD-RWs, DVDs, or any other medium which can be used to store information and which can be accessed within the computing environment 700. In some embodiments, the storage 740 stores instructions for the software 780.

The input device(s) 750 may be a touch input device such as a keyboard, mouse, pen, trackball, touch screen, or game controller, a voice input device, a scanning device, a digital camera, or another device that provides input to the computing environment 700. The output device(s) 760 may be a display, printer, speaker, or another device that provides output from the computing environment 700.

The communication connection(s) 770 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 700, computer-readable media include memory 720, storage 740, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A middleware to automatically bind demographic details of a patient to at least one sensor included in a body worn monitoring device of the patient, the middleware comprises:
a receiver module configured to;
receive identification code from a sensor associated with the patient;
receive a unique patient identification code from a central server; and
receive signals from each sensor associated with the patient; and
an edge intelligence module configured to;
associate the unique patient identification code and the demographic details of the patient with each of the at least one sensor; and
update the central server with sensor identification code of each sensor associated with the unique patient identification code.

2. The middleware of claim 1, wherein said at least one sensor is one of an electronic clinical thermometer, a pulse oximeter and an Electrocardiogram.

3. The middleware of claim 1, wherein the middleware is one of a gateway, a computer, a cellular phone and a personal digital assistant.

4. The middleware of claim 1, further comprising a transmitter module to transmit the signals received from each sensor associated with the patient to the central server.

5. The middleware of claim 1, wherein said central server identifies the unbound unique identifier combination of monitoring entities in a dedicated patient monitoring network and generates the unique patient identification code.

6. The middleware of claim 5, wherein said monitoring entities includes at least one sensor, a gateway, a computer, a cellular phone and a personal digital assistant.

7. The middleware of claim 5, wherein said monitoring entities and the server in the dedicated patient monitoring network communicates via wireless network communication mode.

8. The middleware of claim 5, wherein said monitoring entities and the server in the dedicated patient monitoring network communicates via wired network communication mode.

9. A system to automatically rebind demographic details of a patient to at least one new sensor that has replaced a previously associated sensor included in a body worn monitoring device of the patient, the system comprises:
a central server configured to receive signals from each sensor associated with the patient through an intermediate middleware; and
at least one middleware dedicated to each patient, wherein the at least one middleware has a unique middleware identification code associated with it and stores a unique patent identification code, the middleware comprises;
a receiver module configured to receive unique identification code from the new sensor associated with the patient, the unique identification code comprises a sensor identification code and a null patient identification code; and
an edge intelligence module configured to
update the null patient identification code of the new sensor with the unique patient identification code and associate the demographic details of the patient to the new sensor; and
update the central server with the sensor identification code of the new sensor.

10. The system of claim 9, wherein said at least one sensor is one of an electronic clinical thermometer, a pulse oximeter and an Electrocardiogram.

11. The system of claim 9, wherein said at least one middleware is one of a gateway, a computer, a cellular phone and a personal digital assistant.

12. The system of claim 9, wherein said middleware further comprises a transmitter module to transmit the signals received from each sensor associated with the patient to the central server.

13. The system of claim 9, wherein said central server identifies the unbound unique identifier combination of monitoring entities in a dedicated patient monitoring network and generates the unique patient identification code.

14. The system of claim 13, wherein said monitoring entities includes at least one sensor and a middleware.

15. The system of claim 13, wherein said monitoring entities and the server in the dedicated patient monitoring network communicates via wireless network communication mode.

16. The system of claim 13, wherein said monitoring entities and the server in the dedicated patient monitoring network communicates via wired network communication mode.

17. A system to automatically rebind demographic details of a patient to a new middleware that has replaced a previously associated middleware included in a dedicated patient monitoring network, wherein the patient monitoring network has at least one sensor with a sensor identification code and a unique patient identification code, included in a body worn monitoring device of the patient, the system comprises:
a central server configured to, receive signals from each sensor associated with the patient through the middleware; wherein the new middleware has a unique middleware identification code associated with it and stores a null patient identification code;
the new middleware, comprises;
a receiver module configured to receive the sensor identification code and the unique patient identification code from the sensor associated with the patient;
an edge intelligence module configured to
update the null patient identification code of the new middleware with the unique patient identification code and associate the demographic details of the patient to the new middleware; and,
sends a registration request to the central server, the registration request comprising, the identification code of the new middleware and the unique patient identification code;

18. The system of claim 17, wherein said at least one sensor is one of an electronic clinical thermometer, a pulse oximeter and an Electrocardiogram.

19. The system of claim 17, wherein said new middleware is one of a gateway, a computer, a cellular phone and a personal digital assistant.

20. The system of claim 17, wherein said new middleware further comprises a transmitter module to transmit the signals received from each sensor associated with the patient to the central server.

21. The system of claim 17, wherein said central server identifies the unbound unique identifier combination of monitoring entities in a dedicated patient monitoring network and generates the unique patient identification code.

22. The system of claim 21, wherein said monitoring entities includes at least one sensor and a middleware.

23. The system of claim 21, wherein said monitoring entities and the server in the dedicated patient monitoring network communicates via wireless network communication mode.

24. The system of claim 21, wherein said monitoring entities and the server in the dedicated patient monitoring network communicates via wired network communication mode.

25. A method to automatically rebind demographic details of a patient to a new network device that has replaced a previously associated network device included in a dedicated patient monitoring network, comprises:
receiving a unique patient identification code from at least one network device associated with the patient, wherein the unique patient identification code is generated by a central server;
associating the demographic details of the patient with the new network device;
storing the unique patient identification code at the new network device;
associating the new network device with the central server; and
updating the replaced network device identification code with the new device identification code in the central server;

26. The method of claim 25, wherein said central server identifies the unbound unique identifier combination of network devices in a dedicated patient monitoring network and generates the unique patient identification code.

27. The method of claim 25, wherein said network device is one of a sensor and a middleware.

28. The method of claim 26, wherein said network devices and the server in the dedicated patient monitoring network communicates via wireless network communication mode.

29. The method of claim 26, wherein said network devices and the server in the dedicated patient monitoring network communicates via wired network communication mode.

30. The method of claim 27, wherein said sensor is one of an electronic clinical thermometer, a pulse oximeter and an Electrocardiogram.

31. The method of claim 27, wherein said middleware is one of a gateway, a computer, a cellular phone and a personal digital assistant.

32. A computer program product to automatically bind demographic details of a patient to at least one network device included in a dedicated patient monitoring network, the computer program product comprising a middleware storage medium having computer readable program code embodied in the medium, the computer readable program code comprising at least one:
computer readable program code for receiving identification code and signals from a network device associated with the patient;
computer readable program code for receiving a unique patient identification code from a central server;
computer readable program code to associate the unique patient identification code and demographic details of the patient with each of the at least one network device; and
computer readable program code to update the central server with the network device identification code of each of the at least one network device associated with the unique patient identification code.

33. The computer program product of claim 32, wherein said central server further comprises a computer readable program code to identify unbound unique identifier combination of network devices in the dedicated patient monitoring network and generate the unique patient identification code.

34. The computer program product of claim 32, wherein said at least one network device is one of a sensor and a middleware.

35. The computer program product of claim 34, wherein said sensor is one of an electronic clinical thermometer, a pulse oximeter and an Electrocardiogram.

36. The computer program product of claim 34, wherein said middleware is one of a gateway, a computer, a cellular phone and a personal digital assistant.
